(19) United States
(12) Patent Application Publication
(10) Pub. No.: US 2016/0284024 A1
(43) Pub. Date: Sep. 29, 2016

(54) FINANCIAL DERIVATIVES PRICING METHOD AND PRICING SYSTEM

(71) Applicant: National Central University, TAOYUAN CITY (TW)

(72) Inventors: Huei-Wen TENG, Hsinchu City (TW); Ming-Hsuan KANG, Hsinchu City (TW); Cheng-Der FUH, Taipei City (TW)

(21) Appl. No.: 14/740,271

(22) Filed: Jun. 16, 2015

(30) Foreign Application Priority Data
Mar. 27, 2015 (TW) 104110027

(51) Int. Cl. G06Q 40/06

(52) U.S. Cl. CPC G06Q 40/06

(57) ABSTRACT

A pricing method for financial derivatives is disclosed herein. The pricing method includes receiving a lattice basis corresponding to a multi-dimension space from a database; selecting initial unit vectors on an unit sphere of the multi-dimension space according to the corresponding lattice basis; rotating the initial unit vectors to generate random unit vectors corresponding to the initial unit vectors respectively; selecting corresponding sample points according to the random unit vector; calculating the sampled pay-off values of the sample points according to a pay-off function of a financial derivative; and estimating a price of the financial derivative according to the sampled pay-off values.

### RELATED APPLICATIONS

This application claims priority to Taiwanese Application Serial Number 104110027, filed Mar. 27, 2015, which is herein incorporated by reference.

### BACKGROUND

1. Technical Field

The present disclosure relates to financial derivatives, and in particular, to a financial derivatives pricing method.

2. Description of Related Art

In recent times, with the development of financial derivatives products, it is an important goal for financial institutions to estimate the pricing of financial products and manage the risk thereof while engaging in financial products trading.

In practice, the present pricing systems of financial derivatives often use traditional Monte-Carlo simulation to process the estimation and calculation. However, due to the non-uniform sampling, large variances occur in the calculation result.

Therefore, how to improve the present financial derivatives pricing system and pricing method to lower the variances of the Monte-Carlo simulations to reduce the simulation cost and enhance the calculation efficiency are important areas of research in the field.

### SUMMARY

To solve the problem stated above, one aspect of the present disclosure is a pricing system for financial derivatives. The pricing system for financial derivatives includes a database, a memory and a processing unit. The database is configured to store a plurality of lattice bases, in which the lattice bases are corresponding lattice bases in multi-dimension spaces satisfied the maximum kissing number. The memory is configured to store at least one command. The processing unit is configured to process the at least one command stored in the memory to perform following actions: receiving the lattice basis corresponding to a multi-dimension space from the database; selecting a plurality of initial unit vectors on a unit sphere of the multi-dimension space according to the corresponding lattice basis; rotating the initial unit vectors to generate a plurality of random unit vectors corresponding to the initial unit vectors; selecting a plurality of corresponding sample points according to the random unit vectors; calculating a plurality of sampled pay-off values corresponding to the sample points according to a pay-off function of a financial derivative; and estimating a price of the financial derivative according to the sampled pay-off values.

Another aspect of the present disclosure is a pricing method for financial derivatives. The pricing method includes receiving a lattice basis corresponding to a multi-dimension space from a database; selecting initial unit vectors on an unit sphere of the multi-dimension space according to the corresponding lattice basis; rotating the initial unit vectors to generate random unit vectors corresponding to the initial unit vectors respectively; selecting corresponding sample points according to the random unit vector; calculating the sampled pay-off values of the sample points according to a pay-off function of a financial derivative; and estimating a price of the financial derivative according to the sampled pay-off values.

In summary, technical solutions of the present disclosure have advantages and beneficial effects compared to present technical solutions. The aforementioned technical solutions can be widely used in industry. In the disclosure, by selecting the initial unit vector satisfied the maximum kissing number of the unit sphere on the unit sphere, spherical Monte-Carlo method may be applied to the pricing of the financial derivatives and the accuracy of the estimation may be increased.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a schematic diagram illustrating a financial derivatives pricing system according to an embodiment of the present disclosure;

FIG. 2 is a schematic diagram illustrating a lattice basis of maximum kissing number according to an embodiment of the present disclosure;

FIG. 3 is a flowchart illustrating a financial derivatives pricing method according to an embodiment of the present disclosure.

FIG. 4 is a schematic diagram illustrating a sampling of the spherical monte-carlo simulation according to an embodiment of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

The terms “about” and “approximately” in the disclosure are used as equivalents. Any numerals used in this disclosure with or without “about,” “approximately,” etc. are meant to cover any normal fluctuations appreciated by one of ordinary skill in the relevant art. In certain embodiments, the term “approximately” or “about” refers to a range of values that fall within 20%, 10%, 5%, or less in either direction (greater or less than) of the stated reference value unless otherwise stated or otherwise evident from the context.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

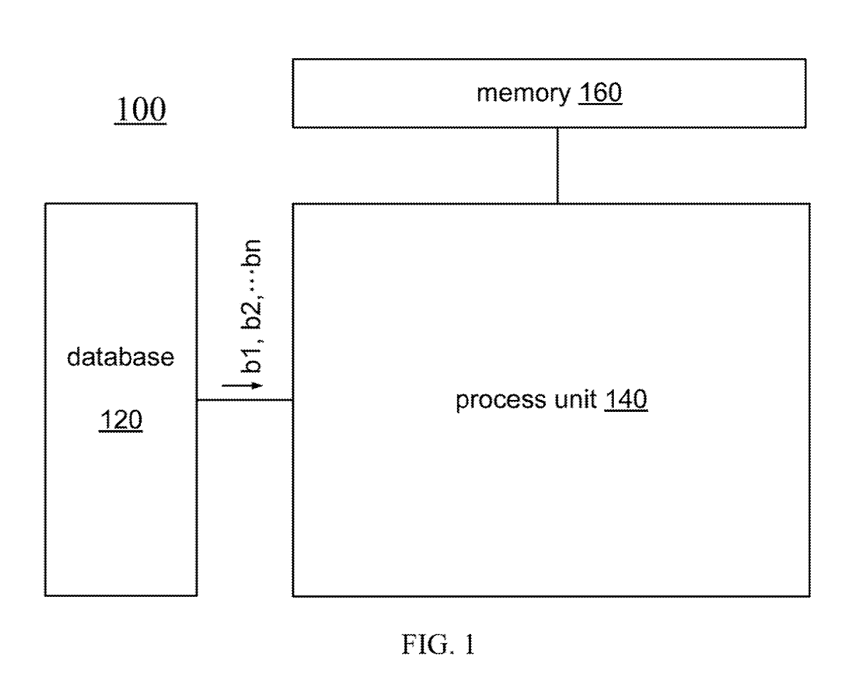

Reference is made to FIG. 1. FIG. 1 is a schematic diagram illustrating a financial derivatives pricing system 100 according to an embodiment of the present disclosure. The financial derivatives pricing system 100 includes a database 120, a processing unit 140 and a memory 160.

The financial derivatives pricing system 100 may be configured to estimate the pricing or the risk value of financial derivative products (i.e., options) by applying spherical monte-carlo method.

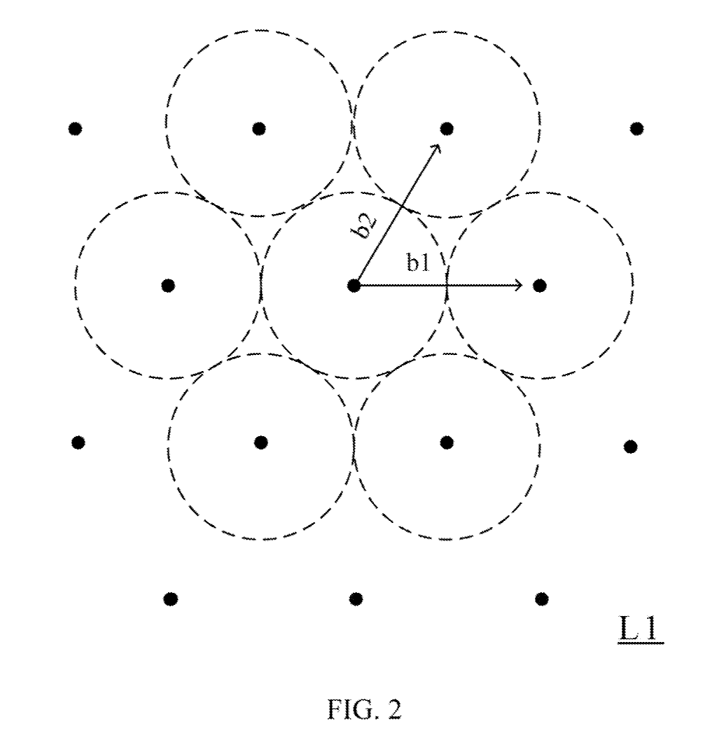

In the present embodiment, the database 120 is configured to store at least one set of lattice basis b1˜bn. The set of integer linear combinations of lattice basis is a set of discrete points in an N-dimension space, called a lattice. Additional reference is made to FIG. 2. FIG. 2 is a schematic diagram illustrating a lattice basis providing the maximum kissing number according to an embodiment of the present disclosure. As shown in FIG. 2, in the present embodiment, the lattice basis b1, b2 stored in database 120 may be used to generate a lattice L1, in which the lattice L1 satisfies the maximum kissing number of the corresponding 2-dimensional space.

Kissing number (also known as Newton number) of an arrangement of unit spheres is defined as the number of unit spheres in the arrangement touching the given unit sphere. Based on the different lattice selected in the N-dimensional space, unit spheres are accumulated in different ways, and thus having different kissing number. In our method, we use several families of root lattices (A₁)^{N}, A_{N}, D_{N} for each dimension N. In the case of high dimensions, we select a root lattice which generates the largest kissing number.

The process unit 140 is configured to operate in accordance with the database 120 to process a command stored in memory 160 to estimate the pricing or risk value of the financial derivatives. In one embodiment, the financial derivatives pricing system 100 may be implemented by a personal computer (PC), in which the process unit 140 is the central processing unit (CPU) and the memory is the random access memory and the hard disk. In another embodiment, the financial derivatives pricing system 100 may be an embedded device, in which the process unit 140 is a microcontroller, and the memory 160 is a random access memory and a flash memory. The embodiments listed above are only by examples and not meant to limit the present disclosure. The specific details and operations of the financial derivatives pricing system 100 will be explained in conjunction with the drawings in the following paragraphs.

It is noted that in the specific implementation of the aforementioned database 120, it is possible to store the database 120 in different storage devices or the same storage device such as hard disks or other computer-readable mediums. One skilled in the art can understand that divide the database into multiple databases, or store the data content from one database to another database are still possible modifications and variations of the present disclosure without departing from the scope or spirit of the disclosure.

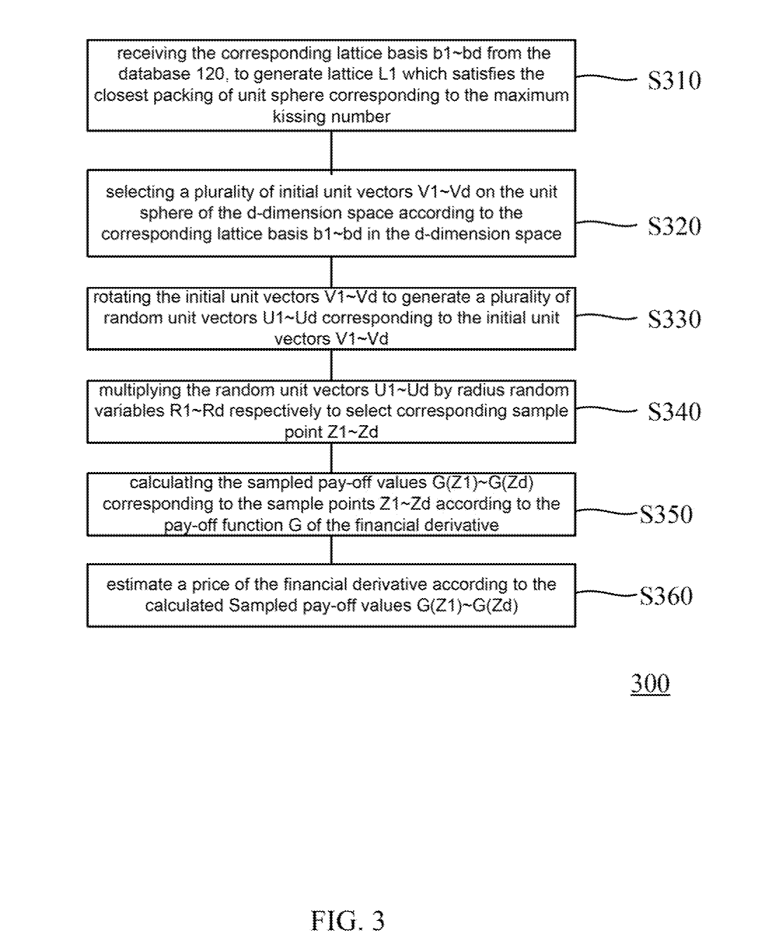

Reference is made to FIG. 3. FIG. 3 is a flowchart illustrating a financial derivatives pricing method 300 according to an embodiment of the present disclosure. For better understanding of the present disclosure, the following method is discussed in relation to the embodiment shown in FIG. 1, but is not limited thereto.

The financial derivatives pricing method 300 may be implemented by a computer, such as the aforementioned financial derivatives pricing system 100. In some embodiments, it is also possible to implement part of the functions in at least one computer program, and store the computer program in a computer-readable medium, in which the computer program includes a plurality of commands, and the commands are configured to be executed on the computer such that the computer is able to perform the financial derivatives pricing method 300. For example, the computer-readable medium may be a read-only memory, a flash memory, a floppy disk, a hard disk, a optical disc, an USB drive, a cassette, a database accessible from the internet or other computer-readable medium known by one skilled in the art having the similar functions.

Specifically, the pricing of the financial derivatives may be estimated via a payoff function G(X). The payoff expected value m is

m=Ep[G(X)].

In which Ep indicates a corresponding expectation operator, G(X) indicates the payoff function in which X is a d-dimensional stochastic vector having a specific distribution with probability density function f(x).

Specifically, in many financial application, stochastic vector X may be a normal random variable having mean vector p and variance-covariance matrix Σ.

Alternatively stated, to estimate the pricing of the financial derivatives, the process unit 140 has to calculate the payoff expected value m efficiently.

To simplify the explanation, in the present embodiment, indication function I_A(x) is used as the payoff function G(X) in order to explain the specific operation in the present method applying spherical monte-carlo method to calculate the probability P of the stochastic vector X belongs to a set A, as the payoff expected value m.

First, for the simplicity of calculation, the process unit 140 may apply the normalization to the stochastic vector X via transformation of variable to obtain a normalized stochastic vector Z. Z is a d-dimensional stochastic vector Z with normal distribution having the mean vector 0 and the variance-covariance matrix I. After above transformation of variable, the probability P may be rewritten based on the probability density function f(x) as the integral of the product of indication function I_A(x) and the probability density function f(x), that is:

P=∫I_A(z)f(z)dz (1)

In the above equation, the monte-carlo estimator can be written as:

\hat{P}=I_A(z)

Next, one point z in a d-dimensional space may be rewritten as a function of a radius r and an unit vector u via the spherical coordinate transformation. Thus, after the spherical coordinate transformation, the integral in the above equation (1) may further be transformed as the radius integral and the spherical integral such as:

$$P = {\int }_{{S}^{d - 1}} {\int }_{0}^{∞} I\_A ( r , u ) kd ( r ) d r d A = \frac{1}{Area ( {S}^{d - 1} )} {\int }_{{S}^{d - 1}} f ( u ) d u \qquad ( 2 )$$

in which the radius integral is:

f(u)=Area(S^{d-1})∫₀^{∞}I_A(r,u)kd(r)dr

Therefore, spherical monte-carlo method may be used to calculate the probability P. During the sampling in the spherical monte-carlo method, a pre-selected initial unit vector V1 on the unit sphere may be multiplied by a random orthogonal matrix T such that the corresponding generated random unit vector U1 will be distributed on the unit sphere uniformly.

Alternatively stated, the process unit 140 may be configured to rotate the initial unit vector V1 to generate the random unit vector U1 corresponding to the initial unit vector V1. In order to make the sample point distributed uniformly to lower the error of the estimation, when sampling multiple sample points, the process unit 140 may apply the closest packing of the multiple-dimensional sphere and the maximum kissing number to select the initial unit vector V1˜Vd.

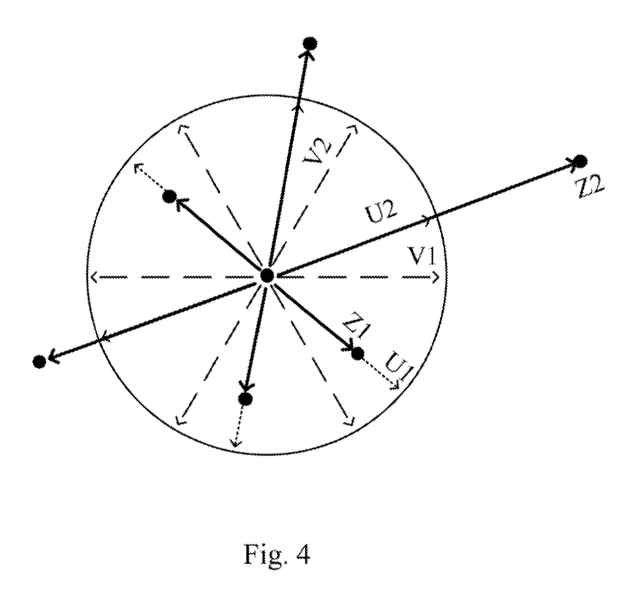

Reference is made to FIG. 3 and FIG. 4. FIG. 4 is a schematic diagram illustrating a sampling of the spherical monte-carlo simulation according to an embodiment of the present disclosure. It is noted that for explanations in a clear and concise manner, the sampling diagram illustrated in FIG. 4 shows a 2-dimensional space to be discussed in relation to the financial derivatives pricing method 300 shown in FIG. 3 as an example, but is not limited thereto. One skilled in the art can understand the financial derivatives pricing method 300 may also be applied in higher dimensional space to estimate the pricing of the financial derivatives.

First, in step S310, the process unit 140 is configured to receive the lattice basis b1˜bd corresponding to d-dimensional space from the database 120, to generate lattice L1 which satisfies the closest packing of unit sphere in d-dimensional space and corresponds to the maximum kissing number in the d-dimensional space.

Next, in step S320, the process unit 140 is configured to select a plurality of initial unit vectors V1˜Vd on the unit sphere of the d-dimension space according to the corresponding lattice basis b1˜bd in the d-dimension space.

Next, in step S330, the process unit 140 is configured to multiply the selected initial unit vectors V1˜Vd on the unit sphere respectively by a random orthogonal matrix T, and rotate the initial unit vectors V1˜Vd to generate a plurality of random unit vectors U1˜Ud corresponding to the initial unit vectors V1˜Vd. Due to the fact that the initial unit vectors V1˜Vd satisfy the closest packing on the unit sphere, after the same random orthogonal matrix T transformation, the random unit vectors U1˜Ud distribute more uniformly than the unit vectors sampled directly, and the variance and errors of the estimation may be reduced accordingly.

Next, in step S340, the random unit vectors U1˜Ud are multiplied by each radius random variables R1˜Rd (i.e., the radius of the multi-dimensional sphere the sample points located) respectively. It is noted that when sampling the radius random variables R1˜Rd, the distribution of random variables R1˜Rd has a specific probability density function kd(r). Thus, the process unit 140 may be configured to select corresponding sample points Z1˜Zd according to the random unit vector U1˜Ud. Alternatively stated, the process unit 140 may be configured to select the corresponding sample points Z1˜Zd according to the random unit vectors U1˜Ud and the radial random variables R1˜Rd corresponding to the random unit vectors U1˜Ud.

Next, in step S350, the sampled pay-off values G(Z1)˜G(Zd) corresponding to the sample points Z1˜Zd may be calculated according to the pay-off function G of the financial derivative. For example, in the present embodiment, the sampled pay-off values may be written as I_A(Z1)˜I_A(Zd). Because the I_A is an indication function and its function value is 1 when the sample points Z1˜Zd are elements of the set A while the function value is zero otherwise, the probability P of the stochastic vector X belongs to the set A can be calculated and estimated.

Finally, in step S360, the process unit 140 is configured to estimate a price of the financial derivative according to the sampled pay-off values. For example, in some embodiments, the process unit 140 is configured to calculate an average value of the sampled pay-off values to estimate the price of the financial derivative.

In some other embodiments, the process unit 140 may also be configured to multiply the sampled pay-off values by a plurality of weights correspondingly, to estimate the price of the financial derivative by importance sampling method. One skilled in the art can understand how to combine the embodiments of the present disclosure to the importance sampling method based on the practical needs to further reduce the error of the estimation.

One skilled in the art can understand that the above descriptions are only by example and not meant to limit the present disclosure. The above method may also used to estimate the risk value of the financial derivatives or other financial applications.

The above description includes exemplary operations, but the operations are not necessarily performed in the order described. The order of the operations disclosed in the present disclosure may be changed, or the operations may even be executed simultaneously or partially simultaneously as appropriate, in accordance with the spirit and scope of various embodiments of the present disclosure.

In summary, in the present disclosure, by applying the embodiments described above, by selecting the initial unit vector satisfied the maximum kissing number of the unit sphere on the unit sphere, spherical Monte-Carlo method may be applied to the pricing of the financial derivatives and the accuracy of the estimation may be increased.

Although the disclosure has been described in considerable detail with reference to certain embodiments thereof, it will be understood that the embodiments are not intended to limit the disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pricing system for financial derivatives, comprising:
a database configured to store a plurality of lattice bases, wherein the lattice bases are corresponding lattice bases in multi-dimension spaces satisfied the maximum kissing number,
a memory configured to store at least one command; and
a processing unit configured to process the at least one command stored in the memory to perform actions comprising:
receiving the lattice basis corresponding to a multi-dimension space from the database;
selecting a plurality of initial unit vectors on a unit sphere of the multi-dimension space according to the corresponding lattice basis;
rotating the initial unit vectors to generate a plurality of random unit vectors corresponding to the initial unit vectors;
selecting a plurality of corresponding sample points according to the random unit vectors;
calculating a plurality of sampled pay-off values corresponding to the sample points according to a pay-off function of a financial derivative; and
estimating a price of the financial derivative according to the sampled pay-off values.

2. The pricing system for financial derivatives of claim 1, wherein the processing unit is further configured to perform actions comprising:
selecting the corresponding sample points according to the random unit vectors and a plurality of radial random variables corresponding to the random unit vectors.

3. The pricing system for financial derivatives of claim 2, wherein the radial random variables have a specific probability density function.

4. The pricing system for financial derivatives of claim 1, wherein the action of estimating the price of the financial derivative according to the sampled pay-off values comprises:
calculating an average value of the sampled pay-off values to estimate the price of the financial derivative.

5. The pricing system for financial derivatives of claim 1, wherein the action of estimating the price of the financial derivative according to the sampled pay-off values comprises:
multiplying the sampled pay-off values by a plurality of weights correspondingly to estimate the price of the financial derivative.

6. A financial derivatives pricing method, comprising:
receiving a lattice basis corresponding to a multi-dimension space from a database;
selecting a plurality of initial unit vectors on an unit sphere of the multi-dimension space according to the corresponding lattice basis;
rotating the initial unit vectors to generate a plurality of random unit vectors corresponding to the initial unit vectors;
selecting a plurality of corresponding sample points according to the random unit vectors;
calculating a plurality of sampled pay-off values of the corresponding sample points according to a pay-off function of a financial derivative; and
estimating a price of the financial derivative according to the sampled pay-off values.

7. The financial derivatives pricing method of claim 6, further comprising:
selecting the corresponding sample points according to the random unit vectors and a plurality of radial random variables corresponding to the random unit vectors.

8. The financial derivatives pricing method of claim 7, wherein the radial random variables have a specific probability density function.

9. The financial derivatives pricing method of claim 6, wherein estimating the price of the financial derivative according to the sampled pay-off values comprises:
calculating an average value of the sampled pay-off values to estimate the price of the financial derivative.

10. The financial derivatives pricing method of claim 6, wherein estimating the price of the financial derivative according to the sampled pay-off values comprises:
multiplying the sampled pay-off values by a plurality of weights correspondingly to estimate the price of the financial derivative.
